(19) United States
(12) Patent Application Publication
(10) Pub. No.: US 2026/0124696 A1
(43) Pub. Date: May 7, 2026

(54) Internal Rotary Plasma Pipe Cutting Device

(71) Applicant: Joseph Dustin Butler, Port Allen, LA (US)

(72) Inventor: Joseph Dustin Butler, Baton Rouge, LA (US)

(73) Assignee: Joseph Dustin Butler, Port Allen, LA (US)

(21) Appl. No.: 18/935,975

(22) Filed: Nov. 4, 2024

(51) Int. Cl. B23K 10/00

(52) U.S. Cl. CPC B23K 10/00

(57) ABSTRACT

A rotary plasma cutter, suitable for the cutting of pipe, pipe piles, and other hollow cylinders, has a frame with a pipe receiving area which is placed at or affixed onto the open end of a pipe or pile and a gear-tracked arm to extend a plasma cutting torch below the pile receiving area and inside of the pipe or pile, while also integrating components to both rotate the entire assembly laterally and extend the plasma torch arm distally to the interior wall of the pipe or pile to efficiently cut a pipe or pile from the inside out without the use of rotary blades or exterior access or footprint. The dimensions and design of the various components are such that the rotary plasma cutter perpendicularly severs the entire circumference of the pipe or pile without excavation or repositioning, so the pipe or pile is trimmed precisely.

### CROSS-REFERENCE TO RELATED APPLICATIONS

This United States non-provisional patent application claims priority to U.S. provisional patent application Ser. 63/593,156 filed Oct. 25, 2023, for all purposes. The dis-closure of that provisional patent application is incorporated herein, to the extent not inconsistent with this disclosure.

### BACKGROUND OF THE INVENTION

This invention relates to a system for cutting of pipe, especially but not exclusively construction foundation pipe piles, frequently used in construction projects of different sorts. It also has application in the manufacturing or maintenance of pipe, in cases where there is a need to cleanly sever a pipe from within rather than from its exterior.

After pipe piles have been installed, their height or length may need to be adjusted in order to accomplish their design objective, to be at a uniform elevation for construction of a level foundation for a structure, for example. Given the variables of the pile driving process and geology, pipe piles frequently are driven to differing initial elevations and need to be trimmed non-destructively to become uniform and usable, without impairing their structural fitness or integrity.

In many cases, pipe piles are driven below ground or below water, such that the exterior of the pile cannot be cleanly accessed without extensive interventions such as excavation or dewatering. As can be readily appreciated, the cutting of a large pipe pile underground or underwater from its exterior can be a significant challenge. However, the interior of the pipe pile is relatively accessible. The interior is isolated from its surroundings by the pipe pile itself, so the interior can be accessed with reduced difficulty compared to the exterior, even if some preliminary internal excavation or dewatering is needed. The interior of the pipe pile can be rendered obstruction-free and accessible much more readily and consistently than its exterior. However, this potential benefit has not previously been realized, as all prior systems and devices for cutting pipes depend on exterior access, to cut the pipe from its exterior rather than from within.

Accordingly, the known prior art pipe cutting systems all present various issues and limitations, giving rise to a desire for an improved pipe cutting system that addresses these issues and introduces new capabilities to the market.

### SUMMARY OF THE INVENTION

Broadly, the internal rotary plasma pipe cutting device embodying the principles of the present invention, also referred to herein at times as the “Butler Device” or “Plasma Cutter”, comprises a single plasma torch mounted on a distally extensible finger, typically pneumatically powered, whose apparatus is affixed to a geared track to travel up and down on a toothed rack gear along the vertical axis inside of a rotary joint slew ring, allowing the entire plasma apparatus to be inserted into the interior of a pipe and rotate three-hundred and seventy degrees laterally across the entire circumference of the pipe being cut, constrained by mechanical stops.

In more detail, the Butler Device has a conventional plasma torch and nozzle which is mounted to an extensible pneumatic or other cylinder to extend the torch and nozzle linearly along the Z-axis against the inner wall of the pipe pile to be cut. The torch and cylinder are mounted on a gear-toothed mast which allows vertical movement along the Y-Axis inside the pipe, and up through the cage opening and into the upper cage of the Butler Device for safe travel and storage. The mast in turn is held inside a slew ring or equivalent rotary apparatus, so that the plasma torch below can rotate laterally along the X-axis to sever all sides of the pipe pile. The operation of the slew ring is constrained by hard stops which prevent the Butler Device from rotating beyond 370 degrees (so that there is a slight overlap for a full cut, while mitigating the potential for hoses to tangle).

The Butler Device integrates several commercially-available components in a value-added, novel configuration to provide a creative solution to a difficult problem. The incorporation of the vertical mechanism through the gear-toothed mast, extensible projection through the torch extension cylinder, and horizontal rotation through the slew ring or other rotating apparatus expand the capabilities of the Butler Device by enabling pile cutting in circumstances in which the depth of the cut is relative to the pile height and/or in which the diameter of the piles to be cut is variable within a pile, oblong or inconsistent among multiple piles. Additionally, because of the described utility features, the Butler Device permits the operator to sever piles from any angle of approach.

For reference or clarification as needed, the Butler Device is differentiated from existing products because—among other reasons—it does not use mechanical cutting implements (such as rotary blades, diamonds, or carbide teeth), nor does it cut from the outside perimeter of the pile, which would require a larger and heavier footprint. The Butler Device is differentiated by the efficiency offered by integrated plasma, the symbiotic combination of the vertical geared track, distal projection cylinder and lateral slew ring, and the smaller footprint which makes it economically useful in more environments, and in a smaller, lighter package.

### BRIEF DESCRIPTION OF DRAWINGS

FIG. 1 is a left-side perspective view of one embodiment of the Butler Device, embodying the principles of the present invention. It is understood that given that the Butler Device is designed to rotate laterally, the front, back, and right-side views are substantially mirror or complementary images of this same view.).

### DETAILED DESCRIPTION OF THE INVENTION

The internal rotary plasma pipe cutting device embodying the principles of the present invention, also referred to herein at times as the “Butler Device” or “Plasma Cutter”, comprises a single plasma torch mounted on a distally extensible cylinder, typically pneumatically powered, whose apparatus is affixed to a geared track to travel up and down on a toothed rack gear along the vertical axis inside of a rotary joint slew ring, allowing the entire plasma apparatus to be inserted into the interior of a pipe and rotate three-hundred and seventy degrees laterally across the entire circumference of the pipe being cut, constrained by mechanical stops.

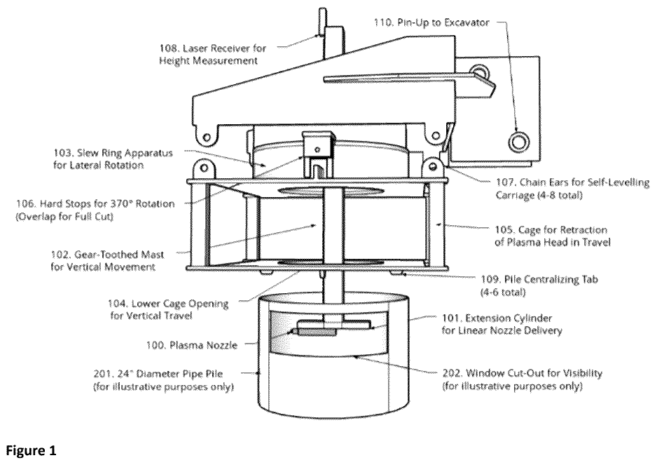

In more detail, referring to FIG. 1, the Butler Device has a conventional plasma torch and nozzle 100 which is mounted to an extensible pneumatic or other cylinder 101 to extend the torch and nozzle 100 linearly against the inner wall of the pipe pile to be cut 201. The torch and cylinder are mounted on a gear-toothed mast 102 which allows vertical movement along the Y-Axis into and throughout the pipe 201, and up through the cage opening 102 and into the upper cage of the Butler Device 105 for safe travel and storage. The mast in turn is held inside a slew ring or equivalent rotary apparatus 103, so that the plasma torch below can rotate laterally or horizontally to sever all sides of the pipe pile. The operation of the slew ring is constrained by hard stops 103 which prevent the Butler Device from rotating beyond 370 degrees (so that there is a slight overlap for a full cut, while mitigating the potential for hoses to tangle).

The incorporation of the vertical mechanism through the gear-toothed mast 102, extensible projection through the torch extension cylinder 101, and horizontal rotation through the slew ring or other rotating apparatus 103 expand the capabilities of the Butler Device by enabling pile cutting in circumstances in which the depth of the cut is relative to the pile height and/or in which the diameter of the piles to be cut is variable within a pile, oblong or inconsistent among multiple piles.

Additional valuable utility features of the Butler Device are that it integrates a series of chains and ear mounts 107 to allow the plasma cutter to self-level independent of what the excavator or crane holding the Butler Device does. In other words, because the chains form a ‘soft’ linkage between the Butler Device and the pipe instead of a rigid linkage, the Butler Device stays in place even if the excavator arm above the pin-up location 110 droops or shifts slightly. In one implementation, the Butler Device incorporates outwardly-rotating distal gripping pads where the centralizing tabs are otherwise 109 to reach into the pipe and apply force against the inner walls of the pipe to center it, hold it in place, and allow the severed end to be safely lifted off and discarded. Lastly, the Butler Device has an integrated housing for a construction grade survey laser 108, so that the operator can cut to the precise final elevation specified by the end user by entering the fixed height offset between the top of the geared mast 102, and its bottom, to which the plasma cylinder 101 is affixed.

To use the Butler Device, it is lifted and positioned (typically via an excavator, crane, or any other capable apparatus) such that the pipe is underneath the retraction cage 105, and centered below gear-toothed mast 104 and plasma nozzle 100, using the centralizing tabs or gripping outwardly-flexing distal fingers 109. Via appropriate controls, the geared mast motor is powered to lower the plasma arm to the desired depth, then in sequence the plasma torch is extended pneumatically into contact with the interior sidewall of the pipe, the plasma torch is turned on, and finally the slew ring is activated to provide lateral rotary delivery of the plasma torch head across the entire circumference of the pipe, perpendicular to its length. A control system, preferably a digital processor combined with mechanical and other elements, keeps the plasma torch advancing at an adjustable specified rate.

When the cut reaches the end of its 370-degree travel path, the plasma torch disengages, the plasma distal delivery finger retracts, and the geared mast raises the plasma components into the retraction cage for safe travel.

It is understood that the electric, hydraulic or pneumatic power sources may be used for the Butler Device's various powered components.).

While the preceding description contains many specificities, it is to be understood that same are presented only to describe some of the presently preferred embodiments of the invention, and not by way of limitation. Changes can be made to various aspects of the invention without departing from the scope thereof. For example, dimensions may be varied to accommodate particular pipe dimensions, etc.; various aspects of the use of the plasma cutter may be automated to some degree; in addition to cutting pipe piles, the apparatus could be readily used to cut other pipes or other hollow implements; various types of equipment can be used to position or power the plasma cutter, including but not limited to an excavator, crane, boom-type machine, etc.

Therefore, the scope of the invention is to be determined not by the illustrative examples set forth above, but by the appended claims and their legal equivalents.

1. An internal rotary plasma pipe cutter, herein at times referred to as “plasma cutter”, comprising:
a. a frame comprising connection points to an excavator or crane, with chain linkages to the carriage below;
b. a self-leveling carriage comprising a rigid retraction cage with a slew ring apparatus for lateral rotation, tie points back to said frame, and pile centralizing tabs;
c. a gear-toothed mast descending from said self-leveling carriage, travelling up and down on geared rollers at an adjustable rate of speed affixed to said self-leveling carriage inside the slew ring;
d. a distally extensible pneumatic cylinder at the bottom of said gear-toothed mast to allow distal extension from the center of the pipe to the inner wall of the pipe at an adjustable rate of speed;
e. a plasma torch affixed to said distally extensible pneumatic cylinder, allowing the plasma torch to be deployed at a regulated rate of speed to the pipe wall; and
f. a series of hoses and piping such that the power supply is securely delivered to the cutting end of the implement without entanglement or pinching during transport, Y-axis vertical extension, X-axis lateral rotation, or Z-axis distal extension.

2. The plasma cutter of claim 1, further comprising a control system comprising a digital processor operatively connected to said plasma cutter and controlling movement, pacing, and the interaction of its components.

3. The plasma cutter of claim 2, wherein the means of deploying the plasma torch comprises the integration of said distally extensible extension cylinder with said self-leveling carriage and slew ring along with said gear-toothed mast.

4. The plasma cutter of claim 3, wherein said means of deploying the plasma torch permits full, functional motion in all three planes, vertically, laterally, and distally, inside the interior of a piper, a space which is otherwise quite restrictive and constricted.

5. The plasma cutter of claim 4, further comprising means for both centering onto the pipe and gripping the pipe to safely facilitate integrated stabilization, holding, relocation, and disposal of the severed end upon completion of the cut.

6. A method of cutting a pipe or pile comprising the steps of:
a. providing a plasma cutter such as the present invention, as previously detailed herein and incorporated in full by reference;
b. positioning the plasma cutter over the pipe or pile to be cut using the centralizing tabs;
c. actuating the pipe gripping pads or fingers;
d. vertically projecting the geared mast into the pipe or pile along the Y-axis;
e. distally projecting the pneumatic extension cylinder along the Z-axis to cause said plasma torch to make continuous contact with the interior side wall of the pipe or pile;
f. actuating said plasma torch remotely to begin cutting; and
g. laterally rotating the entire assembly at an adjustable rate of speed, comprising said geared mast, said extension cylinder, and said plasma torch, to circumnavigate the entire inner circumference of the pipe or pile and allow the actuated plasma torch to cut a complete circular path perpendicular to the length of the pipe or pile, sometimes otherwise known as a square cut.

7. The method of claim 6, in which all operations are integrated and remotely accessible to an operator who is removed from the location of cutting to a safe degree, such that all functions can be managed remotely without manual intervention or close contact with the plasma cutter during operation.

8. The method of claim 6, wherein all functions can be reversed to permit the safe withdrawal of said plasma torch away from the pipe wall, the rotation of said slew ring back to any starting position, and the vertical retraction of said geared mast into said self-leveling carriage with retraction cage for safe travel.
